(19) United States
(12) Patent Application Publication
(10) Pub. No.: US 2011/0296217 A1
(43) Pub. Date: Dec. 1, 2011

(54) MODE CONTROL METHOD

(75) Inventors: Keisuke Nishimura, Kahoku-shi (JP); Yusuke Ono, Kahoku-shi (JP); Ryusuke Imai, Kahoku-shi (JP)

(73) Assignee: PFU LIMITED, Kahoku-shi (JP)

(21) Appl. No.: 12/938,461

(22) Filed: Nov. 3, 2010

(30) Foreign Application Priority Data
Jun. 1, 2010 (JP) 2010-126155

(51) Int. Cl. G06F 1/00

(52) U.S. Cl. 713/323; 713/300

(57) ABSTRACT

An KIOSK terminal 1 capable of transitioning to a power save mode for setting at least one connected target device in a power save status, includes: a first detecting unit 31 capable of detecting a first input during a period for which at least the KIOSK terminal 1 is in the power save mode; a second detecting unit 32 capable of detecting a second input different from the first input, and a mode control unit 33 to finish the power save mode of the KIOSK terminal 1 by making the target device transition to a normal operation status from the power save status, wherein the mode control unit 33, after the first detecting unit 31 has detected the first input and if the second detecting unit 32 detects the second input, finishes the power save mode of the KIOSK terminal 1.

This application is based upon and claims the benefit of priority of the prior Japanese Patent Application No. JP2010-126155, filed on Jun. 1, 2010, the entire contents of which are incorporated herein by reference.

### FIELD

The present invention relates to an information processing device capable of transitioning to a power save mode.

### BACKGROUND

There has hitherto been a power save type data processing device (refer to Japanese Patent Laid-Open Publication No. H04-291612) which enters a sleep mode immediately when an operator leaves the seat in a normal use mode and a proximity sensor such as an infrared-ray sensor detects an absence of the operator and returns to a status before the sleep owing to a resume function by switching on a power source when the proximity sensor detects the return.

Further, there has been also a power source control system for a display device (refer to Japanese Patent Laid-Open Publication No. H06-230860), which includes a power saving circuit to set the display device in a power save status when the proximity sensor does not, for a predetermined or longer period of time, notify of a signal purporting that the operator gets close, determines corresponding to pressing a power switch whether or not the power saving circuit within the display device is in the power save status, then sets the display device in an operation status by instructing the power saving circuit to cancel the power save status when in the power save status, and, while on the other hand, controls the power source to be switched off when not in the power save status.

Such a technology has hitherto existed as to reduce a power consumption by making an information processing device transition to a power save mode when a user does not use the device for a fixed or longer period of time. Then, this type of information processing device, when detecting an input based on a user's operation and an input from a sensor as the user gets close, executes a return process to a mode enabling the user to make a normal use from the power save mode.

Though an occurrence probability becomes different depending on a type of the information processing device and an environment where the information processing device is installed, however, even when detecting an input which triggers the return from the power save mode, actually the user does not start using the information processing device, with the result that an unnecessary return process is to be executed. For example, a KIOSK terminal is installed at a place where a multiplicity of unspecified users comes and goes, and therefore might have a case of detecting an approach of a person who does not aim at using and executing the return process to a normal mode.

It is an object of the present invention to restrain, in view of the problems described above, an unnecessary end of the power save mode in the information processing device.

### SUMMARY

The present invention adopts the following means in order to solve the problems given above. Namely, an information processing device capable of transitioning to a power save mode for setting at least one connected target device in a power save status, includes: a first detecting unit capable of detecting a first input during a period for which at least the information processing device is in the power save mode; a second detecting unit capable of detecting a second input different from the first input; and a mode control unit to finish the power save mode of the information processing device by making the target device transition to a normal operation status from the power save status, wherein the mode control unit, after the first detecting unit has detected the first input and if the second detecting unit detects the second input, finishes the power save mode of the information processing device.

Herein, the “power save status” connotes a power-off status or a status where the information processing device operates with electric power that is, though the power source is switched on, saved more than in the normal operation status. Then, the information processing device according to the present invention enters the power save mode by setting at least one of the devices connected to the information processing device in the power save status. It is to be noted that particularly the device transitioning to the power save status in the power save mode is herein referred to the “target device”.

The information processing device according to the present invention includes the first detecting unit to detect the first input and the second detecting unit to detect the second input, and, after the first detecting unit has detected the first input and further if the second detecting unit detects the second input, finishes the power save mode. With this contrivance, the information processing device according to the present invention does not finish the power save mode in the case of detecting only the first input, which is derived from detecting that the user gets close or the like but enables the power save mode to be restrained from being unnecessarily finished. Further, the information processing device according to the present invention is restrained from unnecessarily finishing the power save mode and therefore improves power saving performance thereof.

It should be noted that the first input and the second input include, though different from each other but if not the same, a plurality of inputs which can be used as the first inputs and the second inputs. For example, as to the input derived from detecting a person at a far distance and an input derived from detecting the person at a near distance, the former input may be treated as the first input, while the latter input may be treated as the second input.

Moreover, the information processing device according to the present invention may further include: an operation device to receive a predetermined operation of a user and to output a signal detected as the second input by the second detecting unit; and a prompt output unit to give an output of prompting the user to perform an operation on the operation device when the first detecting unit detects the first input.

According to the present invention, there is given the output of prompting the user to perform the operation on the operation device. Hence, according to the present invention, the user (trying particularly a first use), who tries to use the information processing device transitioning to the power save mode, can be made to start using the information processing device without misrecognizing that the information processing device is in a power-off status and getting confused to how the operation for a return from the power save mode is done. It should be noted that a method of prompting the user to perform the operation on the operation device is specifically exemplified by voice guidance output from a loudspeaker, flickering of an operation indicating lamp provided in the form of an arrow indicating an operation button and an operation position, display guidance based on an image or a text on a monitor different from a main monitor, and so on.

Moreover, in the information processing device according to the present invention, the output of prompting (the user) is given when the first detecting unit detects the first input, and hence there is no necessity for keeping the power source of a display etc in a power-on status for the purpose of informing the user that the power source of the information processing device is not completely in the power-off status. Namely, according to the present invention, in the information processing device, the power source of the target device (e.g., the display with a backlight etc) having a large power consumption can be switched off.

Further, in the present invention, the operation device may transition to the power save status when the information processing device transitions to the power save mode, and may transition to a normal operation status from the power save status when the first detecting unit detects the first input. Still further, the operation device, after the first detecting unit has detected the first input and if the first input is not detected, may transition to the power save status from the normal operation status.

Namely, the operation device is set in the power save status in the power save mode till the first detecting unit detects the first input and may be set in the normal operation status after detecting the first input, which is defined as a timing when actually operated by the user. With this contrivance, it is feasible to restrain low the power consumption of the operation device used for a process of finishing the power save mode.

Yet further, in the present invention, the mode control unit, after the first detecting unit has detected the first input if the second detecting unit does not detect the second input for a predetermined or longer period of time and if the first input is continuously detected, may finish the power save mode of the information processing device.

After the first detecting unit has detected the first input, even when standing by for the second input related to the second detecting unit, there might be a case where the second input is not detected. For example, this is the case in which the prompt output unit gives the output of prompting the user to perform the operation on the operation device, and nevertheless the user can not grasp this event. A scheme according to the present invention is that, in this case also, if the second detecting unit does not detect the second input for the predetermined or longer period of time and if the first input is continuously detected, the power save mode is to be finished.

Furthermore, the information processing device according to the present invention may further include a user detecting device to detect the user in the vicinity of the information processing device and to output a signal detected as the first input by the first detecting unit.

Moreover, the information processing device according to the present invention may further include a status output unit to give an output for making the user recognize that the information processing device is usable during the period for which at least the information processing device is in the power save mode.

Therefore, according to the present invention, in the information processing device, the power source of the target device (e.g., the display with the backlight etc) having the large power consumption can be switched off without causing the user to misrecognize that the power source of the information processing device is in the power-off status.

Further, the present invention can be grasped as a method executed by a computer or a program to make the computer to execute the method. Still further, the present invention may also be a recording medium recorded with such a program, which can be read by the computer, other devices, other machines, etc. Herein, the recording medium readable by the computer etc connotes a recording medium capable of storing information such as data and programs electrically, magnetically, optically, mechanically or by chemical action, which can be read from the computer etc.

According to the present invention, it is feasible to restrain the unnecessary end of the power save mode in the information processing device.

### BRIEF DESCRIPTION OF THE DRAWINGS

FIG. 1 is a diagram illustrating an outline of a hardware configuration of a KIOSK terminal according to an embodiment;

FIG. 2 is a diagram illustrating an outline of an external configuration of the KIOSK terminal according to the embodiment;

FIG. 3 is a diagram illustrating how the KIOSK terminal according to the embodiment transitions to an operation mode;

FIG. 4 is a diagram illustrating an outline of a functional configuration of the KIOSK terminal according to the embodiment;

FIG. 5 is a flowchart illustrating a flow of a mode control process (1) according to the embodiment; and

FIG. 6 is a flowchart illustrating the flow of the mode control process (2) according to the embodiment.

### DESCRIPTION OF EMBODIMENTS

An embodiment of an information processing device according to the present invention will hereinafter be described based on the drawings. It should be noted that the embodiment, which will hereinafter be discussed, exhibits one example for carrying out the present invention, but the present invention is not limited to a specific configuration that will be described below. It is preferable on the occasion of carrying out the present invention that the specific configuration corresponding to the embodiment is properly adopted. In the embodiment, the information processing device according to the present invention is embodied as a KIOSK terminal installed at a shop. The present invention can be, however, applied to an information processing device capable of shifting a power save mode, and the target device, to which the present invention is applied, is not limited to the KIOSK terminal.

<Configuration>

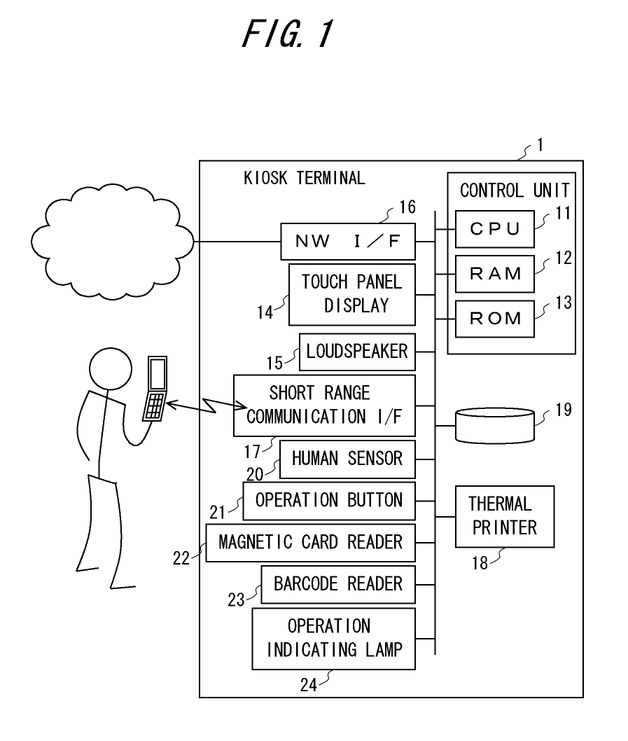

FIG. 1 is a diagram illustrating a hardware configuration of a KIOSK terminal 1 according to the embodiment. The KIOSK terminal 1 is an information processing device including a CPU (Central Processing Unit) 11, a RAM (Random Access Memory) 12, a ROM (Read Only Memory) 13, an auxiliary storage device 19, a touch panel display 14, a loudspeaker 15, a network interface 16, a short range communication interface 17, a thermal printer 18, a human sensor 20, an operation button 21, a magnetic card reader 22, a barcode reader 23 and an operation indicating lamp 24, which are electrically connected to each other. Further, a mouse, a keyboard, etc may further be connected as input devices to the KIOSK terminal 1.

The CPU 11, which is the central processing unit, processes instructions and data deployed on the RAM and the ROM 13, thereby controlling the components provided in the KIOSK terminal 1, such as the RAM 12, the auxiliary storage device 19 and the input/output devices. Moreover, the RAM 12, which is a main storage device, is controlled by the CPU 11, thus writing and reading the variety of instructions and various items of data to and from the RAM 12. Namely, the CPU 11, the RAM 12 and the ROM 13 configure a control unit of the KIOSK terminal 1.

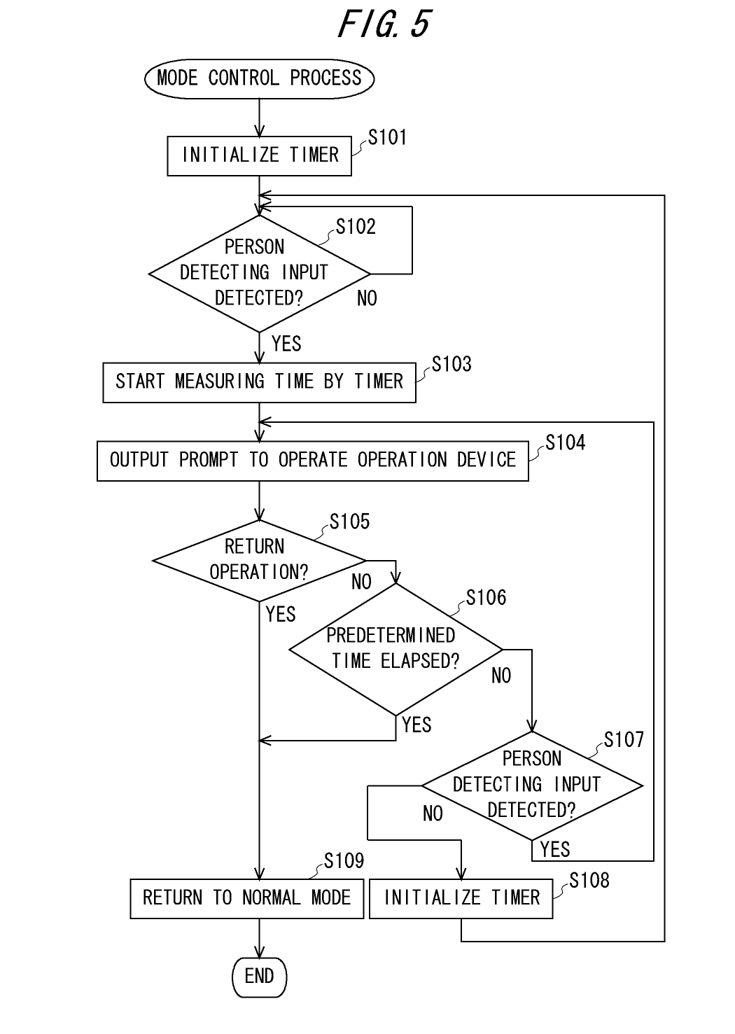

The auxiliary storage device 19 is a nonvolatile storage device to and from which want-to-retain items of information even in a power-off status of mainly the KIOSK terminal 1 such as, in addition to an OS (Operating System) of the KIOSK terminal 1 that is loaded into the RAM 12 and a variety of programs for executing processes given in flowcharts from FIG. 5 onward, various items of data used by the KIOSK terminal 1 are written and read. The auxiliary storage device 19 can involve using, e.g., an EEPROM (Electrically Erasable Programmable ROM), an HDD (Hard Disk Drive), an SSD (Solid State Drive), etc. The I/O device is built up by the touch panel display 14, the variety of buttons, the loudspeaker 15, etc and is controlled by the CPU 11, thereby outputting the data and accepting a user's operation. A content inputted from the I/O device is recorded on the RAM 12 and processed by the CPU 11.

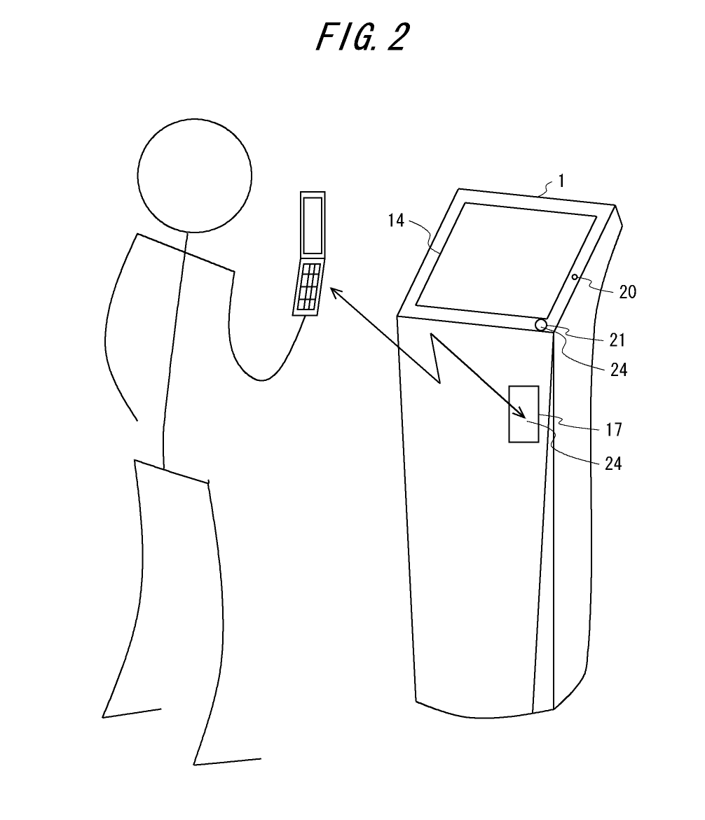

FIG. 2 is a diagram illustrating an outline of an external configuration of the KIOSK terminal according to the embodiment. In the KIOSK terminal 1 according to the embodiment, the I/O device, which involves employing an input/output device constructed mainly of the touch panel display 14 and the buttons, provides the information via a visual sense of the user and accepts an input from the user through a touch operation, a button pressing operation, etc of the user. The user interface may, however, involve using, in addition to the input and output through the screen display on the touch panel display 14 etc, a voice-based input/output employing a microphone (unillustrated) and the loudspeaker 15 and a gesture-based input etc employing a camera (of which an illustration is omitted).

The short range communication interface 17 is a communication interface enabling the terminals communicating with each other to perform the communications when at a given distance or within a given area. To be specific, the short range communication interface 17 in the embodiment adopts a short range communication interface 17 capable of conducting the communications with a non-contact type IC card, i.e., a reader/writer for the non-contact type IC card built in a mobile phone terminal defined as a user terminal (user equipment). Other communication methods such as a non-contact type IC card communication, a wireless LAN (Local Area Network), Bluetooth and RFID (Radio Frequency Identification) may be adopted for the communications between the KIOSK terminal 1 and the user terminal.

The human sensor 20 detects the user in the vicinity of the KIOSK terminal 1 by use of infrared rays or supersonic waves, and, upon detecting the user, output a signal indicating that the user is detected.

In the embodiment, the KIOSK terminal 1 transitions to the power save mode as triggered by an event that the user executes an operation of transitioning to the power save mode for saving the electric power, an event that a predetermined period of time elapses since the user did not perform any operation, or an event that a predetermined period of time elapses since the human sensor did not detect the user. For example, when the operation button 21 is pressed in a normal mode, the KIOSK terminal 1 transitions to the power save mode. Herein, the “power save mode” is defined as an operating mode of setting at least one of the target in-connection devices in a power saving status (including power-off) with a small power consumption. Note that herein the “target device” connotes a device which is previously selected as a transition target device made to transition to the power save status in the power save mode in the devices connected to the KIOSK terminal 1, and is exemplified such as the touch panel display 14, the thermal printer 18 and the auxiliary storage device 19. Then, the KIOSK terminal 1 transitioning to the power save mode returns from the power save mode on the basis of the predetermined trigger (event) and provides a service to the user.

Herein, it is preferable that the KIOSK terminal 1 is installed at, irrespective of outdoor or indoor, a place visited by many people and caught by the eyes of as many people as possible, such as multi-commercial facilities (shopping center), a station, an airport and a cinema complex (movie theater equipped with multiple screens). Therefore, if the return from the power save mode is triggered by the event that the human sensor 20 detects a person, the KIOSK terminal 1 has a possibility of detecting an approach of the person who does not aim at the utility and executing a return process from the power save mode.

Such being the case, the KIOSK terminal according to the embodiment has a scheme of providing a second power save mode (sub power save mode) of standing by for detecting an input based on the user's operation between a first power save mode maintained till detecting an input indicating that the user is detected and a normal mode enabling the user to conduct a normal use.

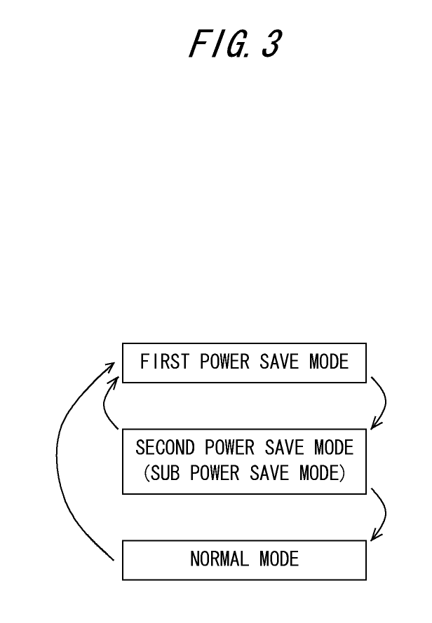

FIG. 3 is a diagram illustrating how the KIOSK terminal 1 according to the embodiment transitions to the operation mode. To be specific, the KIOSK terminal 1 according to the embodiment has the power save mode and the normal mode as the operation modes, and further the power save mode is classified into the first power save mode and the second power save mode (the sub power save mode). The KIOSK terminal 1 according to the embodiment implements a technique for enabling the terminal to transition to these operation modes, thereby restraining the unnecessary return to the normal mode from the power save mode and increasing the power save efficiency.

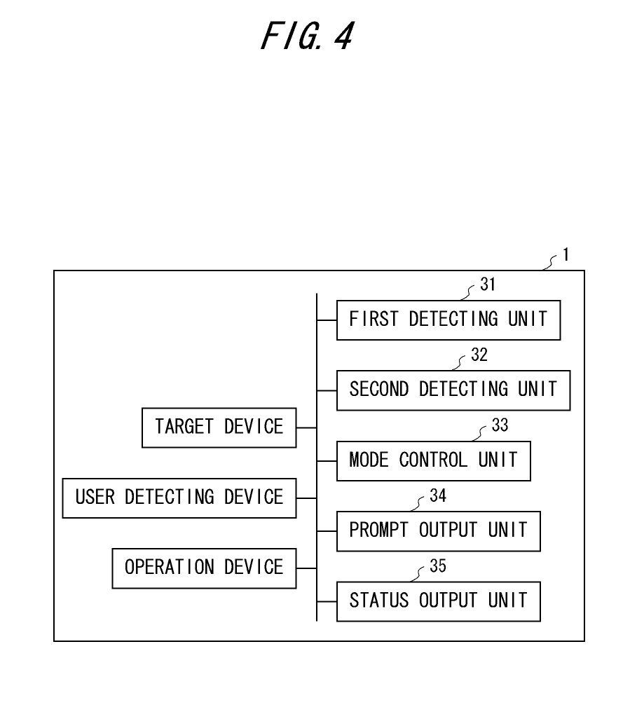

FIG. 4 is a diagram illustrating an outline of a functional configuration of the KIOSK terminal 1 according to the embodiment. The CPU 11 interprets and executes the variety of programs deployed on the RAM 12, whereby the information processing device according to the embodiment functions as the KIOSK terminal 1 including a first detecting unit (module) 31, a second detecting unit (module) 32, a mode control unit 33, a prompt output unit (module) 34 and a status output unit (module) 35. These function units execute functions corresponding to respective means provided in the information processing device according to the present invention. Further, the embodiment discusses an example where these functions are each executed by the general-purpose CPU 11, however, a part or the whole of these functions may also be realized by one or plural dedicated processors.

At least the KIOSK terminal 1 is kept in the power save mode, during which the first detecting unit 31 detects, as a first input, an input indicating that the user is detected from a user detecting device for detecting the user in the vicinity of the KIOSK terminal 1. Herein, the “first input” is the input indicating that the user is detected, and, in the KIOSK terminal 1 according to the embodiment, the human sensor 20 is used as the user detecting device according to the present invention, in which the first detecting unit 31 detects as the first input a signal output by the human sensor 20 and indicating that the user is detected. The user detecting device may, however, involve using a proximity sensor, a shock sensor, an acceleration sensor or a tilt sensor for detecting vibrations of the KIOSK terminal 1 that are caused when the person is approaching, further, in addition, a combination of a camera which captures peripheral images to the KIOSK terminal 1 and a means for extracting a person from the captured images, and a piezoelectric sensor for detecting that the person steps on a floor, a mat, etc ambient to the KIOSK terminal 1.

Moreover, the second detecting unit 32 detects a second input different from the first input. The “second input” connotes an input indicating that the user executes some sort of operation, and inputs from a variety of operation devices are detected as the second inputs in the embodiment. The “operation device” is a device for getting the user to perform a predetermined operation in order to decide whether or not the user detected by the user detecting device is the user who tries to utilize the KIOSK terminal 1. In the KIOSK terminal 1 according to the embodiment, at least any one of the operation button 21, the short range communication interface 17, the magnetic card reader 22 and the barcode reader 23 has a role as an operation device according to the present invention. Note that each of the operation devices such as the operation button 21, the short range communication interface 17, the magnetic card reader 22 and the barcode reader 23 provided with the flicker-enabled operation indicating lamp 24 (an LED (Light Emitting Diode) is used in the embodiment) (see FIG. 2). This type of operation indicating lamp 24 flickers upon receiving an output of the prompt output unit 34, thereby prompting the user to conduct an operation of pressing the operation button 21, an operation of holding up the user terminal over the short range communication interface 17, an operation of inserting the magnetic card into the magnetic card reader 22, and operation of holding up the barcode over the barcode reader 23, and so on.

Note that the operation device transitions to the power save status when the KIOSK terminal 1 transitions to the power save mode, and transitions to a normal operation status from the power save status when the first detecting unit 31 detects the first input. Then, the operation device, when undergoing the predetermined operation of the user in the normal operation status, outputs a signal detected as the second input by the second detecting unit 32. Note that the operation device, though the first detecting unit 31 detects the first input, thereafter if the first input is not detected, transitions to the power save status from the normal operation status. It is to be noted that the operation devices transitioning between the power save status and the normal operation status may be either the whole or a part of the operation devices connected to the KIOSK terminal 1.

The mode control unit 33, after the first detecting unit 31 has detected the first input and further if the second detecting unit 32 detects the second input, makes the target device transition to the normal operation status from the power save status, thereby finishing the power save mode of the KIOSK terminal 1. Moreover, the mode control unit 33, after the first detecting unit 31 has detected the first input and if the second detecting unit 32 does not detect the second input for a predetermined or longer period of time but if the first input continues to be detected, also finishes the power save mode of the KIOSK terminal 1.

The prompt output unit 34, when the first detecting unit 31 detects the first input, gives an output of prompting the user to perform the operation on the operation device. Further, the KIOSK terminal 1 is kept in the power save mode, at least during which the status output unit 35 gives an output for making the user recognize that the KIOSK terminal 1 is usable.

<Details of Process>

FIG. 5 is a flowchart illustrating a flow of a mode control process according to the embodiment. A start of the process illustrated in the flowchart is triggered by an event that the KIOSK terminal 1 transitions to the power save mode after starting up the KIOSK terminal 1. Note that a specific content and processing sequence of the process illustrated in the flowchart are each one examples, and it is preferable that the processing content and the processing sequence suited to the embodiment are properly adopted.

It should be noted that the KIOSK terminal 1 according to the embodiment includes the status output unit 35 which gives the output for making the user recognize that the terminal 1 can start being used immediately when returned from the power save mode, the power source being not necessarily completely off, from any one of the output devices (the operation indicating lamp 24, the loudspeaker 15, etc) provided in the KIOSK terminal 1 also in the case where the KIOSK terminal 1 is in the power save mode.

In step S101, a timer is initialized (reset). This timer is a timer which starts counting when detecting the person in the vicinity of the KIOSK terminal 1 and counts an elapse period of time since the person has been detected. The control unit initializes the timer by resetting a timer value to zero. Thereafter, the processing proceeds to step S102.

In step S102 and step S103, the input indicating the detection of the person is detected, and the elapse time since the detection has been done starts being counted. The first detecting unit 31 detects the input which is output from the human sensor 20 serving as the user detecting device and indicates that the person in the vicinity of the KIOSK terminal 1 is detected (which will hereinafter be referred to as a [first input]) (step S102). In the embodiment, the human sensor 20 is employed as the user detecting device for detecting the person peripheral to the KIOSK terminal 1.

If the first input is not detected, the process in step S102 is repeated till the first input is detected. When the first detecting unit 31 detects the first input, the control unit gets the timer to start counting the time (step S103). In the embodiment, the timer counts seconds since the count has been started. Further, the operation device, if in the power save status at a point of time when the first input is detected, transitions to the normal operation status. Thereafter, the processing proceeds to step S104.

In step S104, there is given the output of prompting the user to conduct the operation on the operation device. When the first detecting unit 31 detects the first input, the prompt output unit 34 outputs information for prompting the user to perform the operation on the operation device (which will hereinafter be also termed a [return operation]). In the embodiment, the prompt output unit 34 outputs, to the loudspeaker 15, voice information for voice-guiding the user, and outputs, to the operation indicating lamp 24, an instruction for flickering the lamp in order to prompt the user to carry out the return operation by indicating the operating position on the operation device. Note that the voice to be output can be uttered such as [Please, press the lower right button on the screen to start using KIOSK terminal] (see FIG. 2 with respect to a position where the operation button 21 is installed).

A discussion on a case of using the operation button 21 provided as the operation device on the KIOSK terminal 1, will be made. The operation indicating lamp 24 of the operation button 21 may be flickered and may also emit the light continuously. Further, available substitutes for flickering the button itself are to give outputs of flickering the operation indicating lamp 24 taking an arrow shape indicating a position of the button and presenting display guidance through a sub display (of which an illustration is omitted) provided other than the touch panel display 14 as a main display. The user existing in the vicinity of the KIOSK terminal 1 can recognize from the thus-output voice and from the flickering of the operation indicating lamp 24 that the KIOSK terminal 1 can be operated and which operation should be conducted to start using the KIOSK terminal 1 by returning the KIOSK terminal 1 in the normal mode.

In the discussion made above, the example of using the operation button 21 as the operation device according to the present invention has been described, however, the operation device is sufficient if capable of giving the output detected as the second input by the second detecting unit 32 in accordance with the user's return operation in order to check whether the user detected by the first detecting unit 31 is the user who tries to actually utilize the KIOSK terminal 1, and is limited to neither the button nor the switch, etc. For example, the operation device may be at least any one of the human sensor 20, the shock sensor, the touch panel, the magnetic card reader 22, a non-contact type card reader and the barcode reader 23 (including a two-dimensional barcodes such as so-called QR (Quick Response) codes), which are provided in or in the periphery of the KIOSK terminal 1.

In the case of using the short range communication interface 17 as the operation device, the prompt output unit 34 gives the output of guiding the user to hold up the user terminal (the non-contact type IC card built in the user terminal) over the short range communication interface 17 (the reader/writer for the non-contact type IC card). Specific operations to be done involve outputting a message (voice or text) such as [Please hold up the mobile phone over the IC card reading unit on lower-right of the screen for the start of using the KIOSK terminal], flickering the operation indicating lamp 24 provided in the short range communication interface 17, flickering the operation indicating lamp 24 provided in the display unit, which takes the arrow shape indicating the position of the short range communication interface 17 (see FIG. 2 with respect to e positions where the short range communication interface 17, the operation indicating lamp 24, etc are installed), and so on. When the user holds up the user terminal over the short range communication interface 17 of the KIOSK terminal 1 according to this guidance, the KIOSK terminal 1 detects that the user terminal is held up over the reading area. When giving the output of prompting the user to perform the return operation, the processing proceeds to step S105.

In step S105, it is determined whether the user performs the return operation or not. When giving the output of prompting the user to do the return operation, the second detecting unit 32 stands by for an input (which will hereinafter be referred to as a [second input]) of a signal output from the operation device and indicating that the user performs the return operation, and determines whether there is the second input or not. If the second detecting unit 32 does not detect the second input, the processing proceeds to step S106. Whereas if the second input is detected, the processing proceeds to step S109.

The operation device outputs the signal indicating that the return operation is conducted when the user performs the return operation, and the second detecting unit 32 detects the output of the operation device as the second input. Herein, a content of the specific return operation carried out by the user is different depending on the type of the operation device. For example, in the case of employing the operation button 21 as the operation device, the user's return operation is an operation of pressing the operation button 21. Further, in the case of using the short range communication interface 17 as the operation device, the user's return operation is an operation of holding up the user terminal etc over the short range communication interface 17. Moreover, in the case of employing the magnetic card reader as the operation device, the return operation is an operation of inserting the magnetic card, and, further in the case of using the barcode reader 23, the return operation is an operation of holding up the barcodes. For others, the operation device can involve employing a variety of devices such as the human sensor 20, the shock sensor and the touch panel, and the return operation executed by the user is different depending on the type of the device.

In step S106 and step S107, it is determined whether or not the time counted by the timer is equal to or longer than a predetermined period of time (e.g., 30 sec), and further it is determined whether the person is continuously detected or not. If the second input is not detected in step S105, the control unit checks the timer value, thereby determining whether or not the predetermined time elapses since the person has been detected in step S102 (step S106). In the case of determining that the predetermined time does not elapse, the first detecting unit 31 detects the input (the first input) from the human sensor 20, thereby determining whether or not the person is continuously detected after being detected in step S102 (step S107). Then, if the person is continuously detected, the processing proceeds to step S104, in which to give again (or continuously) the output of prompting the user to perform the operation on the operation device. Namely, in the mode control process illustrated in the flowchart, if the person existing in the vicinity of the KIOSK terminal is continuously detected, the processes given in step S104 through step S107 are repeated till the predetermined time elapses.

If the person is not detected before the elapse of the predetermined time, i.e., when determining in step S106 that the predetermined time does not elapse and if the person is not detected in step S107, the processing advances to step S108. Then, the KIOSK terminal 1 decides that the person has left from the vicinity thereof, and the control unit gets the timer to stop counting the time and initializes the timer (step S108). Further, the operation device, when transitioning to the normal operation status after detecting the first input in step S102, again transitions to the power save status. Thereafter, the processing proceeds to step S102, and step S102 is repeatedly processed till the person is again detected.

While on the other hand, if the predetermined time elapses in the status where the person is continuously detected, i.e., in the status where the processes given in step S104 through step S107 are repeated because of the person being detected in step S107 and if it is determined in step S106 that the predetermined time elapses, the processing advances to step S109. This is the case in which the prompt output unit 34 gives the output of prompting the user to conduct the operation on the operation device, and nevertheless the user does not grasp this output. According to the embodiment, in such a case also, if the second detecting unit 32 does not detect the second input for the predetermined time (e.g., sec) or longer and if the first detecting unit 31 continuously detects the first input, the processing proceeds to step S109, and the power save mode is terminated. It is therefore preferable that the predetermined time serving as a criterion for the determination is set equal to or longer than the time needed for the user to grasp the position and the operation content of the operation device for returning from the power save mode but less than such a length of time as to refrain the user from giving up utilizing the KIOSK terminal 1 which does not return from the power save mode and moving away from the KIOSK terminal 1.

In step S109, the return to the normal mode is made. Step S109 is executed if the second input is detected in step S105 or when determining in step S106 that the predetermined time elapses. The mode control unit 33 terminates the power save mode of the KIOSK terminal 1 by making the target devices such as the touch panel display 14, which are provided in the KIOSK terminal 1, transition to the normal operation status from the power save status (including the power-off status), whereby the KIOSK terminal 1 is returned to the normal mode enabling the user to utilize normally. Thereafter, the KIOSK terminal 1 operates in the normal mode till the KIOSK terminal 1 transitions to the power save mode as triggered by the event that the user executes the operation of transitioning to the power save mode, or the event that user does not perform the operation, or the event that the predetermined period elapses since the human sensor 20 did not detect any user. Thereafter, the processes illustrated in the flowchart are finished.

The KIOSK terminal 1 according to the embodiment has the second power save mode (the sub power save mode) of standing by for detecting the input based on the user's operation between the first power save mode and the normal mode, thereby restraining the unnecessary return from the power save mode to the normal mode and enabling the power save efficiency to increase. Further, the KIOSK terminal 1 according to the embodiment gives the output of prompting the user to conduct the operation, thereby enabling the power source of the target device having the large quantity of power consumption to be switched off without causing the user to misrecognize that the KIOSK terminal 1 itself is disabled from being used and further enabling the KIOSK terminal 1 to start being used without causing any confusion of the user about the operation for the return from the power save mode.

<Variation of the Process>

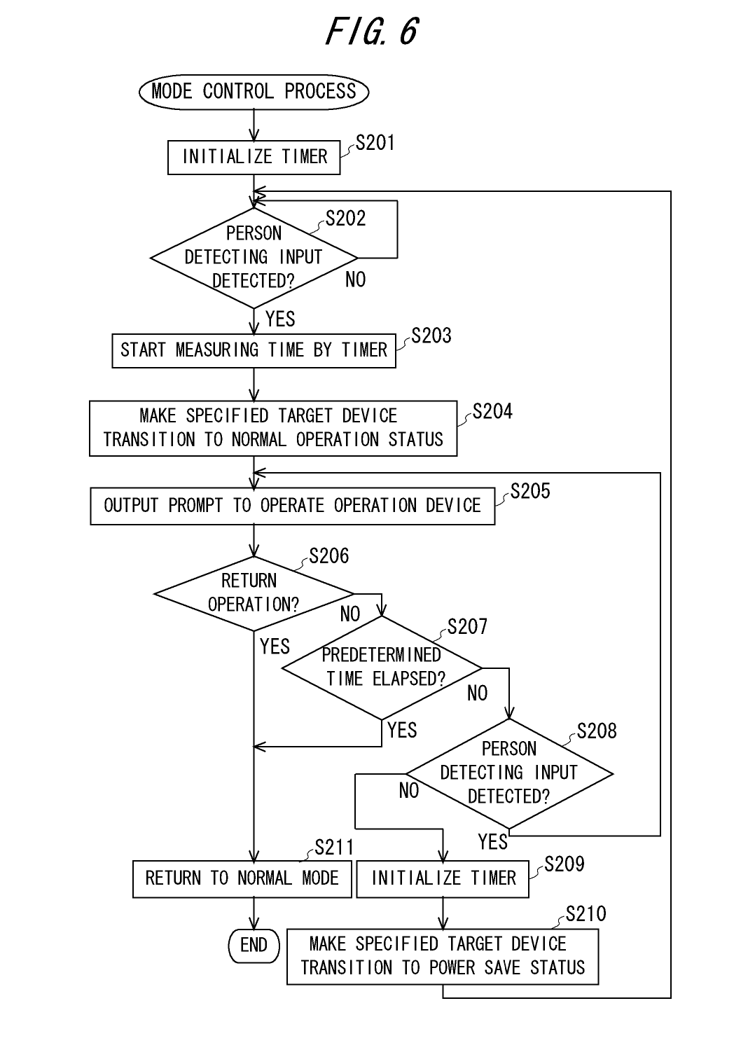

Note that if the target device requiring a considerable length of time for the transition to the normal operation status from the power save status is connected to the KIOSK terminal 1, the time is expended for the transition to the normal mode from the power save mode, with the result that the user waits a long period of time till reaching the operable status. For avoiding such a situation, the target device taking the considerable length of time for the transition to the normal operation status from the power save status may start transitioning to the normal operation status from the power save status immediately after the user detecting device has detected the user. A variation of the mode control process will hereinafter be described with reference to FIG. 6.

FIG. 6 is a flowchart illustrating a flow of the mode control process according to the embodiment. A start of the process illustrated in this flowchart is triggered in the KIOSK terminal 1 by the event that the KIOSK terminal 1 transitions to the power save mode after the KIOSK terminal 1 has been started up. Note that a specific content and processing sequence of the process illustrated in the flowchart are each one examples, and it is preferable that the processing content and the processing sequence suited to the embodiment are properly adopted.

Processes in step S201 through step S203 are substantially the same as the processes in step S101 through step S103 in the flowchart explained as illustrated in FIG. 5, and hence their descriptions are omitted.

In step S204, a specified target device transitions to the normal operation status from the power save status (including the power-off status). Herein, the “specified target device” connotes the target device that is previously selected from within the target devices transitioning to the power save status in the power save mode because of taking the considerable length of time for the transition to the normal operation status from the power save status. The mode control unit 33, with respect to the specified target device taking the considerable length of time for the transition to the normal operation status from the power save status, gets this specified target device to start transitioning to the normal operation status at a point of time when the first input is detected in step S202. Thereafter, the processing proceeds to step S205.

Processes in step S205 through step S209 and step S211 are substantially the same as the processes in step S104 through step S108 and step S109 in the flowchart explained as illustrated in FIG. 5, and hence their explanations are omitted.

Namely, in the mode control process illustrated in the flowchart, the specified target device taking the considerable length of time for the transition to the normal operation status from the power save status, is made to start transitioning to the normal operation status at the point of time when the first input is detected in step S202, and other target devices are made to transition to the normal operation status in step S211. This transition process being thus executed, according to the mode control process illustrated in the flowchart, it is feasible to complete the transitions of all of the target devices connected to the KIOSK terminal 1 to the normal operation status from the power save status, thus enabling the user to utilize the terminal 1 without waiting for the long period of time.

In step S210, the specified target device transitions to the power save status. If the person is not detected before the predetermined time elapses, i.e., if the person is not detected in step S208, the KIOSK terminal determines that the user has left from the vicinity thereof, and the mode control unit 33 gets the specified target device made to start transitioning to the normal operation status in step S204 to again transition to the power save status. Thereafter, the processing proceeds to step S202, and step S202 is repeated till the person is again detected.

What is claimed is:

1. An information processing device capable of transitioning to a power save mode for setting at least one connected target device in a power save status, comprising:
a first detecting unit capable of detecting a first input during a period for which at least said information processing device is in the power save mode;
a second detecting unit capable of detecting a second input different from the first input; and
a mode control unit to finish the power save mode of said information processing device by making said target device transition to a normal operation status from the power save status,
wherein said mode control unit, after said first detecting unit has detected the first input and if said second detecting unit detects the second input, finishes the power save mode of said information processing device.

2. An information processing device according to claim 1, further comprising:
an operation device to receive a predetermined operation of a user and to output a signal detected as the second input by said second detecting unit; and
a prompt output unit to give an output of prompting the user to perform an operation on said operation device when said first detecting unit detects the first input.

3. An information processing device according to claim 2, wherein said operation device transitions to the power save status when said information processing device transitions to the power save mode, and transitions to a normal operation status from the power save status when said first detecting unit detects the first input.

4. An information processing device according to claim 3, wherein said operation device, after said first detecting unit has detected the first input and if the first input is not detected, transitions to the power save status from the normal operation status.

5. An information processing device according to claim 1, wherein said mode control unit, after said first detecting unit has detected the first input if said second detecting unit does not detect the second input for a predetermined or longer period of time and if the first input is continuously detected, finishes the power save mode of said information processing device.

6. An information processing device according to claim 1, further comprising a user detecting device to detect the user in the vicinity of said information processing device and to output a signal detected as the first input by said first detecting unit.

7. An information processing device according to claim 1, further comprising a status output unit to give an output for making the user recognize that said information processing device is usable during the period for which at least said information processing device is in the power save mode.

8. A mode control method by which a computer capable of transitioning to a power save mode for setting at least one connected target device in a power save status, executes:
detecting a first input during a period for which at least said computer is in the power save mode;
detecting a second input different from the first input; and
finishing the power save mode of said computer by making said target device transition to a normal operation status from the power save status,
wherein said finishing involves, after the first input has been detected and if the second input is detected, finishing the power save mode of said computer.

9. A readable-by-computer recording medium recorded with a program for mode control to make a computer capable of transitioning to a power save mode for setting at least one connected target device in a power save status, execute:
detecting a first input during a period for which at least said computer is in the power save mode;
detecting a second input different from the first input; and
finishing the power save mode of said computer by making said target device transition to a normal operation status from the power save status,
wherein said finishing involves, after the first input has been detected and if the second input is detected, finishing the power save mode of said computer.
